(19) United States
(12) Patent Application Publication
(10) Pub. No.: US 2009/0282335 A1
(43) Pub. Date: Nov. 12, 2009

(54) ELECTRONIC DEVICE WITH 3D POSITIONAL AUDIO FUNCTION AND METHOD

(76) Inventor: Petter Alexandersson, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/115,812

(22) Filed: May 6, 2008

(51) Int. Cl. G06F 3/048

(52) U.S. Cl. 715/716

(57) ABSTRACT

An electronic device is provided that plays back a collection of media objects. The electronic device includes a controller that assigns a virtual spatial location within a virtual space to a sample of each media object and plays back at least one of the samples to a user through a multichannel audio device. Each played sample is within a virtual audible range of a virtual user position in the virtual space, and each played sample is played using spatial audio so that the user perceives each played sample as emanating from the corresponding virtual spatial location within the virtual space. The electronic device further includes a navigation device that inputs navigational signals to the controller to move the virtual user position relative to the virtual space in accordance with user manipulation of the navigation device. In response to the received navigational input, the controller adjusts the playback to maintain a correspondence between the virtual spatial location of each played sample and the virtual user position.

### TECHNICAL FIELD OF THE INVENTION

The technology of the present disclosure relates generally to electronic devices and, more particularly, to electronic devices with a three-dimensional (3D) positional audio function.

### BACKGROUND

Mobile and/or wireless electronic devices are becoming increasingly popular. For example, mobile telephones, portable media players, and portable gaming devices are now in widespread use. In addition, the features associated with certain types of electronic devices have become increasingly diverse. To name a few examples, many electronic devices have cameras, text messaging capability, Internet browsing capability, electronic mail capability, media playback capability (including audio and/or video playback) image display capability, and handsfree headset interfaces.

Many electronic device users store a large number of media objects (e.g., songs, videos, etc.) in their electronic devices (commonly referred to as the “media library”). The contents of the media library may be graphically presented to the user using icons and/or text describing the title, artist, album, genre, year of release, etc., or various combinations thereof.

However, organizing and/or browsing an especially large media library can be unwieldy. For instance, due to the large number of media objects, it may be difficult to obtain an overview of the entire media library, and individually selecting each object in the library to sample its contents can be time-consuming and bothersome. Furthermore, the user may have forgotten some contents of the media library, and simply browsing a long list of song titles, for example, may not effectively refresh the user's memory. Moreover, visually browsing a media library can consume a large portion of the user's visual attention, which may be disadvantageous when it is not convenient for the user to observe a visual display.

One tool for managing media objects is the playlist, a well-known feature of electronic devices with media playback capability. Playlists define a group of media objects set forth in some predetermined order and can be created by the user, generated automatically, downloaded by the user, etc., or various combinations thereof. Electronic devices refer to a selected playlist to determine the particular media objects that are to be played and the order in which they are to be played. In the event that a particular playlist is not selected, a default playlist may include all media objects in the order in which they are stored in the media library.

Nonetheless, using playlists to organize and/or browse through a media library has its limitations, especially when the library is particularly large. For instance, in order to create a customized playlist, the user undertakes the cumbersome task of browsing each individual object in the media library to locate the desired contents. Also, managing a multitude of playlists and/or scrolling through each object in an especially long playlist still can be bothersome. Furthermore, in the event that a user does not remember the contents of a playlist, browsing a list of song titles, for example, still is an ineffective way to refresh the user's memory.

### SUMMARY

To facilitate the management of media objects, the present disclosure describes an improved electronic device and method for browsing a collection of media objects. In one embodiment, real time 3D positional audio is used to reproduce the browsing experience in an auditory manner, allowing a user to sample of a plurality of media objects at a time.

According to one aspect of the invention, an electronic device that plays back a collection of media objects includes a controller that assigns a virtual spatial location within a virtual space to a sample of each media object and plays back at least one of the samples to a user through a multichannel audio device. Each played sample is within a virtual audible range of a virtual user position in the virtual space, and each played sample is played using spatial audio so that the user perceives each played sample as emanating from the corresponding virtual spatial location within the virtual space. The electronic device further includes a navigation device that inputs navigational signals to the controller to move the virtual user position relative to the virtual space in accordance with user manipulation of the navigation device. In response to the received navigational input, the controller adjusts the playback to maintain a correspondence between the virtual spatial location of each played samples and the virtual user position.

According to one embodiment of the electronic device, in response to received navigational input to move the virtual user position toward the virtual spatial location of a user specified one of the samples, the controller adjusts the playback so that the user perceives the user specified sample with prominence over other played samples in the virtual audible range to provide user perception of being located at the corresponding virtual spatial location.

According to an embodiment of the electronic device, in response to a received input command, the controller plays back the media object corresponding to the user specified sample from a beginning of the media object.

According to another embodiment of the electronic device, the adjustment of the playback in response to received navigational input to move the virtual user position toward a user specified sample includes exclusive playback of the user specified sample.

According to yet another embodiment of the electronic device, the adjustment of the playback in response to received navigational input to move the virtual user position toward a user specified sample includes playback of the user specified sample in stereo.

According to still another embodiment of the electronic device, the electronic device further includes a display driven to display a graphical simulation of the virtual space, the graphical simulation including graphical objects that represent the virtual spatial locations of the samples, wherein the graphical simulation is updated in response to the received navigational inputs.

According to another embodiment of the electronic device, each media object is an individual audio file.

According to one embodiment of the electronic device, each media object is a playlist having plural audio files.

According to an embodiment of the electronic device, in response to a received input command, the controller plays back samples of the audio files from the playlist using spatial audio to represent a spatial layout of the audio files.

According to another embodiment of the electronic device, each media object is associated with at least one audio file or at least one video file.

According to yet another embodiment of the electronic device, the navigation inputs are generated by moving the electronic device.

According to another aspect of the invention, a method of browsing a collection of media objects using an electronic device includes (a) assigning a virtual spatial location within a virtual space to a sample of each media object; (b) playing back at least one of the samples to a user through a multichannel audio device, wherein each played sample is within a virtual audible range of a virtual user position in the virtual space and wherein each played sample is played using spatial audio so that the user perceives each played sample as emanating from the corresponding virtual spatial location within the virtual space; and (c) in response to a received navigational input to move the virtual user position relative to the virtual space, adjusting the playback to maintain a correspondence between the virtual spatial location of each played sample and the virtual user position.

According to one embodiment of the method, in response to received navigational input to move the virtual user position toward the virtual spatial location of a user specified one of the samples, the method provides adjusting the playback so that the user perceives the user specified sample with prominence over other played samples in the virtual audible range to provide user perception of being located at the corresponding virtual spatial location.

According to an embodiment of the method, in response to a received input command, the method provides playing back the media object corresponding to the user specified sample from a beginning of the media object.

According to another embodiment of the method, the adjusting of the playback in response to received navigational input to move the virtual user position toward a user specified sample includes exclusively playing back the user specified sample.

According to yet another embodiment of the method, the adjusting of the playback in response to received navigational input to move the virtual user position toward a user specified sample includes playing back the user specified sample in stereo.

According to still another embodiment of the method, the method further includes displaying a graphical simulation of the virtual space, the graphical simulation including graphical objects that represent the virtual spatial locations of the samples; and updating the graphical simulation in response to the received navigational inputs.

According to one embodiment of the method, each media object is an individual audio file.

According to another embodiment of the method, each media object is a playlist having plural audio files.

According to an embodiment of the method, in response to a received input command, the method provides repeating steps (a), (b), and (c) using the audio files of a user specified one of the playlists as the media objects.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a mobile telephone as an exemplary electronic device;

FIG. 2 is a schematic block diagram of the relevant portions of the electronic device of FIG. 1;

FIG. 3 illustrates an exemplary graphical user interface screen display on the electronic device of FIG. 1;

FIG. 4 illustrates another exemplary graphical user interface screen display on the electronic device of FIG. 1;

FIG. 5 is a schematic diagram representing exemplary virtual audio sources as presented to a user;

FIG. 6 graphically represents an exemplary adjustment of the virtual spatial locations of the audio sources in FIG. 5 as presented to a user;

FIG. 7 is a flowchart representing a method of browsing a collection of media files using a three-dimensional (3D) positional audio function; and

FIG. 8 illustrates an exemplary graphical user interface screen display on the electronic device of FIG. 1.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smartphone, a portable communication apparatus, etc.

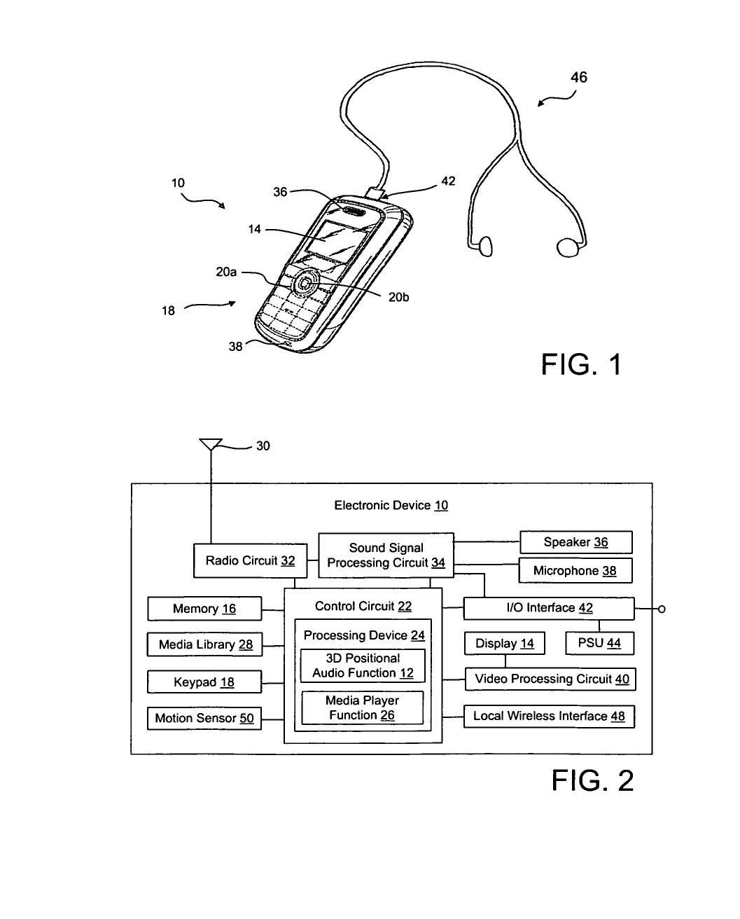

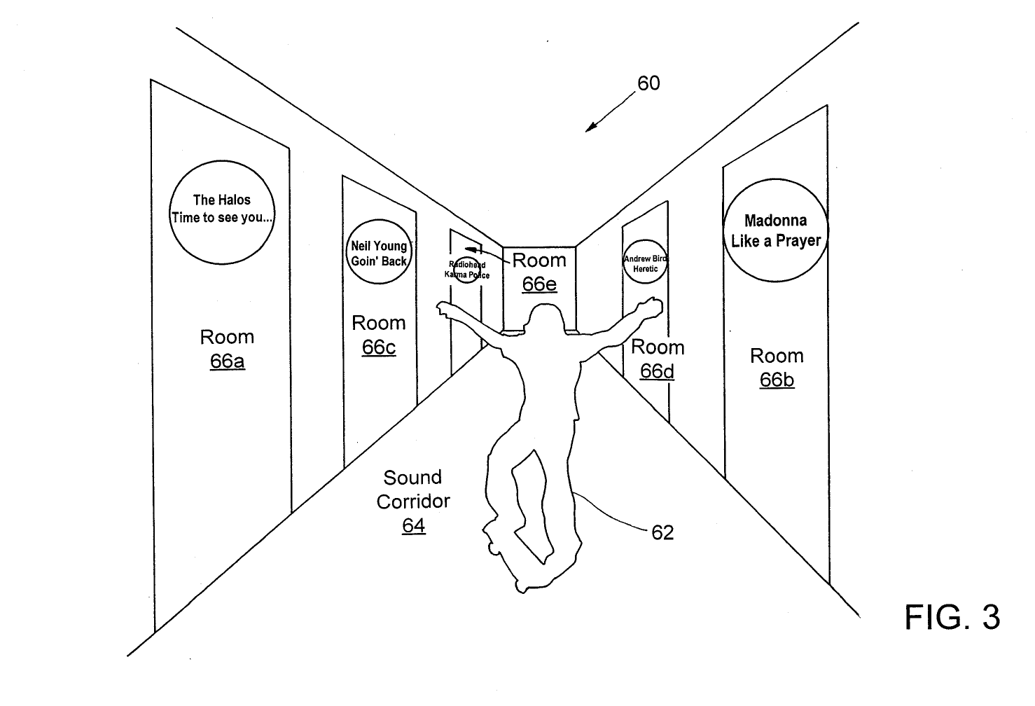

Referring initially to FIGS. 1 and 2, an electronic device 10 is shown. The electronic device 10 includes a three-dimensional (3D) positional audio function 12 that is configured to present the playback of media objects so that each media object appears to originate from a different virtual spatial location. Additional details and operation of the 3D positional audio function 12 will be described in greater detail below. The 3D positional audio function 12 may be embodied as executable code that is resident in and executed by the electronic device 10. In one embodiment, the 3D positional audio function 12 may be a program stored on a computer or machine readable medium. The 3D positional audio function 12 may be a stand-alone software application or form a part of a software application that carries out additional tasks related to the electronic device 10.

The electronic device of the illustrated embodiment is a mobile telephone that is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The electronic device 10 may include a display 14. The display 14 displays information to a user, such as operating state, time, telephone numbers, contact information, various menus, etc., that enable the user to utilize the various features of the electronic device 10. The display 14 also may be used to visually display content received by the electronic device 10 and/or retrieved from a memory 16 (FIG. 2) of the electronic device 10. The display 14 may be used to present images, video, and other graphics to the user, such as photographs, mobile television content, and video associated with games.

A keypad 18 provides for a variety of user input operations. For example, the keypad 18 may include alphanumeric keys for allowing entry of alphanumeric information such as telephone numbers, phone lists, contact information, notes, text, etc. In addition, the keypad 18 may include special function keys such as a “call send” key for initiating or answering a call and a “call end” key for ending or “hanging up” a call. Special function keys also may include menu navigation keys 20, for example, to facilitate navigating through a menu displayed on the display 14. For instance, a pointing device and/or navigation key(s) 20a may be present to accept directional inputs from a user, and a select key 20b may be present to accept user selections. In one embodiment, the navigation key(s) 20a is a rocker switch. Special function keys may further include audiovisual content playback keys to start, stop, and pause playback, skip or repeat tracks, and so forth. Other keys associated with the electronic device may include a volume key, an audio mute key, an on/off power key, a web browser launch key, etc. Keys or key-like functionality also may be embodied as a touch screen associated with the display 14. Also, the display 14 and keypad 18 may be used in conjunction with one another to implement soft key functionality.

As will be described in more detail below, the electronic device 10 is a multi-functional device that is capable of carrying out various functions in addition to traditional electronic device functions. For example, the exemplary electronic device 10 also functions as a media player. More specifically, the electronic device 10 is capable of playing different types of media objects such as audio files (e.g., MP3, .wma, AC-3, etc.), video files (e.g., MPEG, .wmv, etc.), still images (e.g., pdf, JPEG, .bmp, etc.). The mobile phone 10 is also capable of reproducing video or other image files on the display 14, for example.

FIG. 2 represents a functional block diagram of the electronic device 10. For the sake of brevity, many features of the electronic device 10 will not be described in great detail. The electronic device 10 includes a primary control circuit 22 that is configured to carry out overall control of the functions and operations of the electronic device 10. The control circuit 22 may include a processing device 24, such as a central processing unit (CPU), microcontroller, or microprocessor. The processing device 24 executes code stored in a memory (not shown) within the control circuit 22 and/or in a separate memory, such as the memory 16, in order to carry out operation of the electronic device 10. The memory 16 may exchange data with the control circuit 22 over a data bus.

In addition, the processing device 24 may execute code that implements the 3D positional audio function 12 and a media player function 26. The media player function 26 is used within the electronic device 10 to play various media objects, such as audio files, video files, picture/image files, etc., in a conventional manner. It will be apparent to a person having ordinary skill in the art of computer programming, and specifically in application programming for electronic devices or other electronic devices, how to program a electronic device 10 to operate and carry out logical functions associated with the 3D positional audio function 12 and the media player function 26. Accordingly, details as to specific programming code have been left out for the sake of brevity. Also, while the 3D positional audio function 12 and the media player function 26 are executed by the processing device 24 in accordance with an embodiment, such functionality could also be carried out via dedicated hardware or firmware, or some combination of hardware, firmware, and/or software.

The electronic device 10 includes a media library 28 in accordance with an embodiment of the. The media library 28 represents a storage medium that stores various media objects in the form of audio files, video files, picture/image files, etc. The storage medium preferably is a non-volatile memory such as a large capacity flash memory or micro-hard drive, each of which are well known in personal media players. In a more limited context, the media library 28 may be represented by a relatively small capacity compact disk (CD), mini-disk, flash card, etc., each of which may be inserted into the electronic equipment for reproduction of the media objects thereon. Alternatively, media object(s) also may reside on remote storage. For example, the media objects may reside on a remote server also accessible by the electronic device 10 via a wireless Internet connection. As another alternative, the media library 28 may be included in the memory 16.

Continuing to refer to FIGS. 1 and 2, the electronic device 10 includes an antenna 30 coupled to a radio circuit 32. The radio circuit 32 includes a radio frequency transmitter and receiver for transmitting and receiving signals via the antenna 30 as is conventional. The radio circuit 32 may be configured to operate in a mobile communications system and may be used to send and receive data and/or audiovisual content.

The electronic device 10 further includes a sound signal processing circuit 34 for processing audio signals transmitted by and received from the radio circuit 32. Coupled to the sound processing circuit 34 are a speaker 36 and a microphone 38 that enable a user to listen and speak via the electronic device 10. The radio circuit 32 and sound processing circuit 34 are each coupled to the control circuit 22 so as to carry out overall operation. Audio data may be passed from the control circuit 22 to the sound signal processing circuit 34 for playback to the user. The audio data may include, for example, audio data associated with a media object stored in the media library 28 and retrieved by the control circuit 22, or received audio data such as in the form of streaming audio data from a mobile radio service. The sound processing circuit 34 may include any appropriate buffers, decoders, amplifiers, and so forth.

The display 14 may be coupled to the control circuit 22 by a video processing circuit 40 that converts video data to a video signal used to drive the display 14. The video processing circuit 40 may include any appropriate buffers, decoders, video data processors, and so forth. The video data may be generated by the control circuit 22, retrieved from a video file that is stored in the media library 28, derived from an incoming video data stream that is received by the radio circuit 32, or obtained by any other suitable method.

The electronic device 10 may further include one or more I/O interface(s) 42. The I/O interface(s) 42 may be in the form of typical electronic device I/O interfaces and may include one or more electrical connectors. As is typical, the I/O interface(s) 42 may be used to couple the electronic device 10 to a battery charger to charge a battery of a power supply unit (PSU) 44 within the electronic device 10. In addition, or in the alternative, the I/O interface(s) 42 may serve to connect the electronic device 10 to a headset assembly 46 (e.g., a personal handsfree (PHF) device) or other audio reproduction equipment that has a wired interface with the electronic device 10. In an embodiment, the I/O interface 42 serves to connect the headset assembly 46 to the sound signal processing circuit 34 so that audio data reproduced by the sound signal processing circuit 34 may be output via the I/O interface 42 to the headset assembly 46. Further, the I/O interface(s) 42 may serve to connect the electronic device 10 to a personal computer or other device via a data cable for the exchange of data. The electronic device 10 may receive operating power via the I/O interface(s) 42 when connected to a vehicle power adapter or an electricity outlet power adapter. The PSU 44 may supply power to operate the electronic device 10 in the absence of an external power source.

The electronic device 10 also may include a local wireless interface 48, such as an infrared transceiver and/or an RF interface (e.g., a Bluetooth interface) for establishing communication with an accessory, another mobile radio terminal, a computer, or another device. For example, the local wireless interface 48 may operatively couple the electronic device 10 to a wireless headset assembly (e.g., a PHF device) or other audio reproduction equipment with a corresponding wireless interface.

The electronic device 10 may include a motion sensor 50 for detecting motion of the electronic device 10 and producing a corresponding output. For example, in an embodiment of the, the motion sensor 50 may be used to accept directional inputs so that a user may navigate through a menu or other application by tilting the electronic device 10 in the direction of the desired movement (e.g., left, right, up, and down). The motion sensor 50 may be any type of motion sensor, including, for example, an accelerometer (e.g., single-axis or multiple-axis), which senses the acceleration of the electronic device 10. Alternatively, the motion sensor 50 may be a simple mechanical device such as a mercury switch or pendulum type apparatus for sensing movement of the electronic device 10. As will be appreciated, the particular type of motion sensor 50 is not germane to the.

The motion sensor 50 may be initiated by a user via one or more keys on the electronic device 10. Upon initiation and movement of the electronic device 10, the motion sensor 50 produces a signal indicative of the motion of the electronic device 10. This motion signal is provided to the control circuit 22 and more particularly, to the processing device 24, which processes the motion signal using known techniques. The motion sensor 50 may be configured such that the motion signal is provided to the control circuit 22 only in instances where the user decidedly moves the electronic device 10. For example, the processing device 24 may require that the motion signal from the motion sensor 50 be maintained for at least a predetermined time and/or amplitude prior to issuing an associated command signal, as will be appreciated.

According to an embodiment, the media library 28 may include one or more playlists that are created by the user or otherwise provided within the electronic device 10. A playlist identifies a list of media objects that the electronic device 10 is to reproduce during playback. The media objects appear in the playlist in the order in which the media objects are intended to be reproduced normally (i.e. in the absence of a shuffle or randomization operation). The user may generate the playlist(s), or the user may download the playlist. Alternatively, the electronic device 10 may generate the playlist (e.g., based on a user input, such as genre, artist, album, year of release, etc., or a mood of the user as determined by the electronic device 10). As another alternative, the playlist(s) may be stored in the memory 16. In yet another alternative, playlist(s) may reside on remote storage, e.g., on a remote server accessible by the electronic device 10 via a wireless Internet connection. The particular manner in which the playlists are generated is not germane in this disclosure, as will be appreciated.

In accordance with conventional media player operation, the user will select a playlist from among those in the media library 28 via a user interface typically in combination with the display 14. Alternatively, the user may request that the media player function 26 create a playlist automatically (e.g., based on genre, artist, album, year of release, etc.). As yet another alternative, the media player function 26 will revert to a default playlist in the absence of a specified selection by the user. Such a default playlist may result from the order in which media objects are stored in and/or retrieved from the media library 28. For example, the media player function 26 may revert to a default playlist where the media player function 26 plays the media objects stored in the media library 28 beginning at a starting address and sequentially there-through to an ending address.

A user may initiate the media player function 26 via one or more keys of the keypad 18 on the electronic device 10. Upon initiation, the media player function 26 analyzes the selected (or default) playlist and identifies the first media object in the list. Thereafter, the media player function 26 proceeds to reproduce the media object via the speaker 36/headset 46 and/or display 14. More particularly, the media player function 26 accesses the media object in the media library 28 and converts the digital data to an audio and/or video signal that is presented to the speaker 36/headset 46 and/or display 14. For example, the media player function 26 may direct audio to the speaker 36/headset 46 via the sound signal processing circuit 34. Upon completing the reproduction of the first media object in the playlist, the media player function 26 may proceed to reproduce the next media object in the playlist in the same manner. This process may continue until the media player function 26 reproduces the last media object in the playlist.

The contents of the media library 28 and/or a playlist may be graphically presented to the user on the display 14 in a text-based list format, each list entry containing information about a corresponding media object. For example, for each audio file stored in the media library 28, the corresponding list entry may include the audio file's title, artist, album, genre, year of release, etc., or various combinations thereof. Alternatively, the media objects may be presented on the display 14 as a collection of icons. Each icon may be labeled with at least one piece of information about the media object, for example, the title of the object.

According to conventional media player operation, a user may browse through the media library 28 or a playlist by using, for example, the navigation key(s) 20a to scroll through the list of media objects presented on the display 14. As noted above, when the media library 28 includes a particularly large number of media objects, the browsing process can be cumbersome and time-consuming in that the user must scroll through each media object in a long list of objects in order to locate and select desired objects and/or obtain an overview of the media library 28. Moreover, if a user has forgotten the contents of the media library 28, scrolling through a list of titles, for example, may not be sufficient to refresh the user's memory. Furthermore, if the user wishes to sample portions of the media library 28 in order to remember forgotten contents, the user may browse the contents by individually selecting each media object, stopping playback of the object when finished sampling, and/or navigating to and selecting the next object, if any. Using playlists to organize the media library 28 does not necessarily eliminate the limitations of conventional media player operation because creating a customized playlist includes at least the same browsing process described above. And browsing a multitude of playlists or a particularly long playlist can still be time-consuming and bothersome for at least the same reasons above.

Accordingly, the electronic device 10 includes the 3D positional audio function 12 for enhancing a user's experience when browsing a collection of media files. In an embodiment, real time 3D positional audio is used to present an audio sample of each media object that the user encounters while browsing the media library 28. While browsing the library 28, the user may navigate towards certain media objects and navigate away from other media objects. The 3D positional audio function 12 reproduces this browsing experience in an auditory manner. More specifically, as a user encounters media objects in the media library 28, audio samples of the media objects are presented by the media player function 26 to the 3D positional audio function 12 before presenting the samples to, for example, headset 46. The 3D positional audio function 12 uses 3D positional audio to position, in real time, the playback of each audio sample so that each sample appears to originate from a spatially separated audio source located in a virtual space. As the user navigates through the media library 28, the 3D positional audio function 12 adjusts, in real time, the audio playback from each virtual audio source accordingly, so that the audio playback presented to the user via, for example, the headset 46 represents the movement of the user through the media library 28. For example, as a user navigates towards a media object in the media library 28, the virtual audio source associated with that object is perceived to move closer to the user. Similarly, as a user navigates away from a media object, the virtual audio source associated with that object is perceived to move away from the user. And if the user lingers at a certain position within the media library 28, the virtual spatial position of that audio source is perceived to remain unchanged.

As will be appreciated, when the media library 28 is graphically presented in a conventional list format, more than one media object may be visible on the display 14 at a given time. Similarly, the 3D positional audio function 12 may simultaneously present a plurality of media objects in sample format depending on the user's browsing position in the media library 28. And because each sample is perceived to originate from a spatially separated audio source, the user is able to distinguish the audio playback of each sample. While an unlimited number of media objects may be simultaneously reproduced in sample format, a user may have difficulty distinguishing between each sample if too many are played at a time, as will be appreciated. In addition, being presented with several audio samples appearing to originate from several different virtual spatial locations may cause listening discomfort.

In an embodiment, the processing device 24 uses a predefined set of parameters to determine which and how many media objects should be reproduced in sample format at a given time. These parameters define an audible range. Accordingly, the user is presented with playback of audio samples from the virtual audio sources that fall within this audible range. For example, only the three media objects that are closest to the user's current browsing position in the media library 28 may be reproduced as audio samples at a time. Alternatively, more or less than three media objects may be reproduced at a given time. The exact number of audio sources within the user's audible range may vary, as will be appreciated. Additional details regarding the user's audible range will be described in greater detail below.

In accordance with an embodiment, an audio sample represents a segment of the media object that lasts for a predefined time. For example, the audio sample may be a forty-second segment of the media object. In addition, the audio sample may be any randomly selected segment of the media object. For example, the audio sample may be taken from the beginning of the media object, the end of the media object, or at any segment there-between. Alternatively, the audio sample may be the entire media object from start to finish.

The user may utilize a multi-channel headset (e.g., the headset 46 shown in FIG. 1) or other multi-channel audio reproduction arrangement (e.g., multiple audio speakers positioned relative to the user) to reproduce the audio data in accordance with the described techniques. For purposes of explanation, it is assumed, unless otherwise specified, that the audio data associated with each media object is reproduced using a two-channel audio format. This explanation is exemplary, and it will be appreciated that the disclosed techniques may be used with other multi-channel audio formats (e.g., 5.1, 7.1, etc.). In such case, spatial imaging is provided in the same manner, except over additional audio reproduction channels.

Turning now to FIG. 3, an exemplary screen display (e.g., screenshot) is shown illustrating a graphical user interface 60 that may be presented to a user when browsing the media library 28 using the 3D positional audio function 12 of the electronic device 10. The graphical user interface 60 provides a visualization of the user's auditory browsing experience when using the 3D positional audio function 12. The graphical user interface 60 includes an avatar 62 that may be controlled by a user of the electronic device 10 by entering directional inputs via, for example, the navigation key(s) 20a. The avatar 62 is shown in a sound corridor 64 with rooms 66 on either side of the sound corridor 64. The user may navigate the avatar 62, for example, forwards or backwards through the sound corridor 64 and left or right into any of the rooms 66. The sound corridor 64 represents the virtual space in which a user of the electronic device 10 appears to exist when browsing the media library 28 using the 3D positional audio function 12. The avatar 62 represents the user within the virtual space, and the position of the avatar 62 represents the user's browsing position within the library 28. Each of the rooms 66 represents the virtual spatial location from which an audio sample of a media object is perceived to originate. As the user navigates the avatar 62 through the sound corridor 64, the user hears different audio samples playing from the rooms 66 that are within the user's audible range.

As shown in FIG. 3, a first room 66a represents an audio source playing a sample of the song “Time to see you . . . ” by the artist The Halos, and a second room 66b represents an audio source playing a sample of the song “Like a Prayer” by the artist Madonna. Similarly, a third room 66c represents an audio source playing a sample of the song “Goin' Back” by the artist Neil Young, while a fourth room 66d represents an audio source playing a sample of the song “Heretic” by the artist Andrew Bird. And fifth room 66e represents an audio source playing a sample of the song “Karma Police” by the artist Radiohead.

As explained briefly above, the audible range determines which of the audible samples playing from rooms 66 may be heard by the user at a given position in the sound corridor 64. As a room moves out of the user's audible range, a new room may become audible in its place. In the example of FIG. 3, the avatar 62 is positioned in the sound corridor 64 between the first room 66a and the second room 66b, with the third room 66c and the fourth room 66d located just ahead of the avatar 62 and the fifth room 66e located further down the sound corridor 64. From the user's perspective, only the audio samples playing from, for example, the first room 66a, the second room 66b, and the third room 66c may be audible. However, as the user navigates the avatar 62 forwards, the audio samples playing from the first room 66aand/or the second room 66b may become inaudible. And the user may begin to hear the audio samples playing from the fourth room 66d and/or the fifth room 66e, in addition to the sample playing from the third room 66c. Eventually, as the avatar 62 approaches the end of the sound corridor 64, the audio samples playing from the third room 66c and/or the fourth room 66d may become inaudible as well and only the audio sample playing from the fifth room 66e may be audible. The user reaches the end of the sound corridor 64 when the user has reached the end of the media library 28.

According to the exemplary embodiment, a user may select a media object for full playback by moving the avatar 62 into the virtual room that is playing the corresponding audio sample. If, for example, the user would like to hear Neil Young's “Goin' Back” in its entirety, the user navigates the avatar 62 towards the third room 66c until the avatar 62 enters room 66c. For example, the user may move the avatar 62 forward and to the left via the navigation key(s) 20a in order to enter the third room 66c. While inside room 66c, the audio sample of “Goin' Back” is played back, for example, in full stereophonic sound, and no other audio samples are audible inside the virtual room. Once the avatar 62 is inside room 66c, the user may press the select key 20b, for example, to begin playback of the desired song from the beginning of the song. If, after entering room 66c and listening to the selected audio sample in full stereo, the user decides not to playback the associated song, the user may “de-select” the audio sample by navigating the avatar 62 out of room 66c and into the sound corridor 64. For example, where the user presses left to enter a room and thereby select an audio sample, the user may press right to exit a room and thereby de-select the audio sample. As the avatar 62 re-enters the sound corridor 64, the 3D positional audio function 12 begins playing audio samples from the different virtual rooms 66 in accordance with the principles described herein.

As shown in FIG. 3, the avatar 62 is depicted as a young man on a skateboard, and each of the five doorways to the rooms 66 are labeled with a circle containing the title and artist of the song associated with that room. However, it will be appreciated that other approaches are contemplated. The avatar 62 may take any shape or form. For example, the user may be prompted to select an avatar from a variety of different avatars provided by the manufacturers of the electronic device 10 or a service that supports the disclosed functions. Alternatively, the user may be able to create a customized avatar. Similarly, the rooms 66 in the sound corridor 64 may have labels of any shape or form, including labels designated by the user. For example, each of the doorways to the rooms 66 may be labeled with the album cover art of the song associated with that room.

It will be appreciated that FIG. 3 shows only an exemplary embodiment of a graphical user interface. The disclosed techniques are not limited to any particular number or placement of virtual rooms 66 or any particular shape or size of virtual sound corridor 64. For example, the number of rooms 66 is not limited to five or any other number. The number of rooms 66 displayed via the graphical user interface 60 may depend on the number of media objects in the media library 28 and the user's browsing position in the library 28.

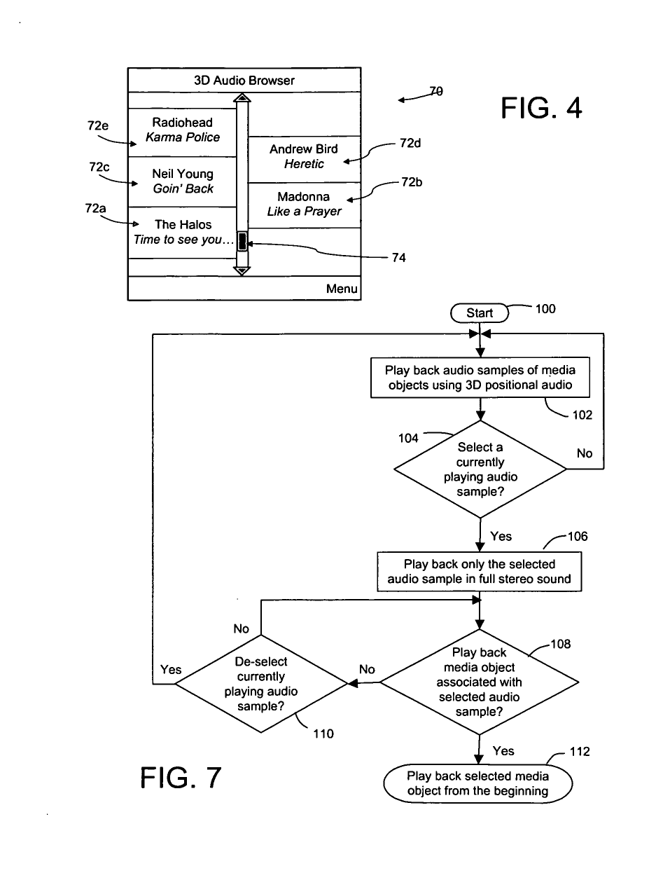

Referring now to FIG. 4, another exemplary screen display is shown illustrating a graphical user interface 70 that may be presented to a user when browsing the media library 28 using the 3D positional audio function 12 of the electronic device 10. The graphical user interface 70 presents a text-based list of media objects in the media library 28. A user browses through the media library 28 by using the navigation key(s) 20a, for example, to control a sliding bar 74. The media objects are positioned to the left and right of the sliding bar 74 at positions 72. The sliding bar 74 may represent the user's location within the media library 28 and/or the user's location in virtual space according to the 3D positional audio function 12. The positions 72 of the media objects correspond to the virtual spatial locations from which the audio samples of the objects appear to originate when presented using 3D positional audio. Thus, when the sliding bar 74 is at the location shown in FIG. 4, the user may hear an audio sample of the song “Time to see you . . . ” by the Halos playing from a position 72a directly to the left of the user. In addition to “Time to see you . . . ” playing on the left, the user may also hear an audio sample of the song “Like a Prayer” by Madonna playing from a position 72b on the right of the user. As the user moves the sliding bar 74 up towards a position 72c, the “Time to see you . . . ” sample may become less audible, while an audio sample of “Goin' Back” by Neil Young, for example, may become more audible.

In accordance with an embodiment, a user may select a media object for full playback by moving the sliding bar 74 until the sliding bar 74 is next to the position 72 associated with the desired media object, navigating left or right so as to highlight the desired media object, and pressing the select key 20b. For example, if a user wants to play Andrew Bird's “Heretic,” the user moves the sliding bar 74 up until the sliding bar 74 is next to a position 72d and navigates right via the navigation key(s) 20a to highlight the text at position 72d. Once the desired object is highlighted, the user may press the select key 20b to being playback of the media object. While an object is highlighted, the associated audio sample is played back, for example, in full stereophonic sound, and no other audio samples are audible. In the instant embodiment, if the user decides not to play back the highlighted media object in full, the user may de-select the media object by navigating left via, for example, the navigation key(s) 20a, so that the media object is no longer highlighted. When no media object is highlighted, the 3D positional audio function 122 positions audio samples at positions 72 in accordance with the principles described herein.

In FIG. 4, the sliding bar 74 is placed in the middle of the graphical user interface 70. However, the sliding bar 74 need not be positioned in this location. For example, the sliding bar 74 may be positioned to the far right of the interface 70. Similarly, while only the title and artist of each media object is shown in the graphical user interface 70, other information, such as genre, year of release, etc., may be displayed in addition to or in lieu of the title and/or artist information. It will be appreciated that the disclosed techniques are not intended to be limited to the depiction of FIG. 4.

While the exemplary embodiments of FIGS. 3 and 4 illustrate graphical user interfaces that are presented to a user when using the 3D positional audio function 12 to browse through a collection of media objects, it will be appreciated that the 3D positional audio function 12 may operate without providing an accompanying visualization on the screen display of the electronic device 10. In such an embodiment, the user may still browse through a collection of media objects via the auditory impression presented by the 3D positional audio function 12. And the user may still navigate through the collection using, e.g., the menu navigation keys 20. In an alternative embodiment, while a user browses a media collection using the 3D positional audio function 12, the display 14 may display a conventional list of media objects, for example, without any graphical correlation with the virtual spatial locations from which the audio samples appear to be originating.

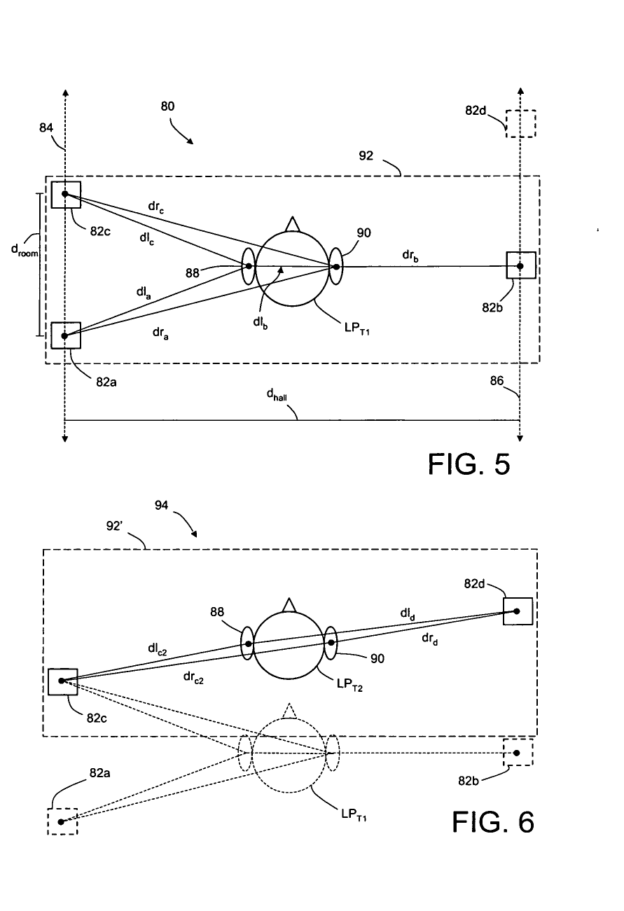

FIG. 5 illustrates a virtual spatial arrangement 80 of audio sources 82 as presented to a user using the 3D positional audio function 12 in accordance with any of the embodiments discussed above. As illustrated, the user of the electronic device 10 is positioned at listening position LP_{T1}. From the perspective of the user, audio samples of three media objects appear to be originating from audio sources 82a, 82b, and 82c, respectively. In the present example, no audio playback is audible from audio source 82d. Audio playback of media objects in sample format may be presented to the user via, for example, headset 46.

As shown in FIG. 5, the audio sources 82a and 82c are aligned on a left axis 84, while the audio sources 82b and 82d are aligned on a right axis 86. The axis 84 represents an axis extending through the center of each audio source on the left of the listening position LP_{T1}. Similarly, the axis 86 represents an axis extending through the center of each audio source on the right of the listening position LP_{T1}. The distance between axis 84 and axis 86 may be represented by dₕₐₗₗ. The audio sources 82 are placed at regularly spaced intervals along each axis. For example, the distance between audio source 82a and audio source 82c may be represented as dᵣₒₒₘ, while the distance between audio source 82b and audio source 82d may also be represented as dᵣₒₒₘ. The listening position LP_{T1} is centered between both axes, e.g., at a distance dₕₐₗₗ/2 from either axis. The distances dₕₐₗₗ and dᵣₒₒₘ can be any value, and may be selected so as to represent a comfortable physical spacing between the audio sources 82 and the listening position LP_{T1} in a “real life” auditory experience. For example, dₕₐₗₗ may be preselected to be 1.0 meter, and dᵣₒₒₘ may be preselected to be 0.5 meter, or dₕₐₗₗ and/or dᵣₒₒₘ could be any other value as will be appreciated.

Spatial imaging techniques of 3D positional audio are used to give the user the auditory impression that audio samples are being played from audio sources 82a, 82b, and 82c, for example. Such spatial imaging techniques are based on the virtual distances (e.g., dl, dr) between each of the audio sources 82 and the left and right ears (88, 90) of the user. For example, the virtual distance between the left ear 88 and the audio source 82a can be represented by dlₐ. Similarly, the virtual distance between the right ear 90 and the audio source 82a can be represented by drₐ. Likewise, the distances between the left and right ears (88, 90) and the audio source 82b can be represented by dl_{b} and dr_{b}, respectively. The distances between the left and right ears (88, 90) and the audio source 82c can be represented by dl_{c} and dr_{c}, respectively. The left ear 88 and the right ear 90 are separated from one another by a distance hw (not shown) corresponding to the headwidth or distance between the ears of the user. For purposes of explanation, the distance hw is assumed to be the average headwidth of an adult, for example. Applying basic and well known trigonometric principles, each of the distances dl and dr corresponding to the audio sources 82 can be determined easily based on a predefined dₕₐₗₗ, dᵣₒₒₘ, and hw.

The virtual distances dl and dr for each of the audio sources 82 are used to determine spatial gain coefficients that are applied to the audio data associated with respective audio sources 82 in order to reproduce the audio data to the left and right ears (88, 90) of the user in a manner that images the corresponding virtual spatial locations of the audio sources 82 shown in FIG. 5. More specifically, the spatial gain coefficients are utilized to adjust the amplitude of the audio data reproduced to the left and right ears (88, 90) of the user. The spatial gain coefficients take into account the difference in amplitude between the audio data as perceived by the left and right ears (88, 90) of the user due to the differences in distances dl and dr that the audio signal must travel from each of the audio sources 82 to the left and right ears (88, 90) of the user. By adjusting the amplitude in this manner, the audio data is perceived by the user as originating from the corresponding spatial locations of the virtual audio sources 82.

In addition, spatial imaging techniques of 3D positional audio may be used to simulate the effect of other variables on an audio signal. For example, the audio data may be adjusted to simulate reverberation caused by sound reflecting from the walls and/or floors of a room, such as the virtual corridor 64 in FIG. 3.

The 3D positional audio function 12 may utilize, for example, an algorithm to position the audio data received from the media player function 26 so as to provide spatial imaging in accordance with the principles described above. It will be appreciated that the audio data may be single-channel, e.g., monaural sound, or multi-channel, e.g., stereophonic sound. According to an embodiment, if stereophonic audio data is received from the media player function 26, the 3D positional audio function 12 converts the stereophonic audio into monaural audio via, for example, software. Alternatively, such functionality may be implemented via hardware, firmware, or some combination of software, hardware, and/or firmware.

As indicated above, an audible range determines how many and which media objects to reproduce in sample format at a given time using 3D positional audio. The audible range is a predefined set of parameters that is configured to provide the user with a comfortable listening experience. FIG. 5 illustrates an exemplary audible range 92 that is represented by a rectangle centered on the listening position LP_{T1}. The manufacturer of the electronic device 10 (or developer of the 3D positional audio function 12, if not the electronic device manufacturer) may define the parameters of the rectangle (or other shape) that represents the audible range 92. Alternatively, the audible range 92 may be user adjustable. Only the audio sources 82 with virtual spatial locations that fall within the audible range 92 will be presented using 3D positional audio. As shown in FIG. 5, audio source 82d does not fall within the audible range 92 and therefore, audio source 82d is not presented to the user using 3D positional audio. As the user browses through the media library 28 and the user's position in virtual space correspondingly changes, the audible range 92 moves with the user so as to remain centered on the user's current virtual position. While the audible range 92 is shown as a rectangle in FIG. 5, it will be appreciated that the particular shape or form of the audible range 92 may be different.

In an alternative embodiment, the audible range 92 may be based on the virtual distances dl and dr. For example, by taking an average of the virtual distances dl and dr associated with each audio source 82, an average virtual distance d_{avg} may be determined. According to such an embodiment, the three audio sources 82 that are closest to the listening position LP_{T1}, e.g., have the shortest average virtual distance d_{avg}, may be included within the audible range 92. If more than one audio source 82 has the same average virtual distance d_{avg} and the total number of qualifying audio sources is greater than three, the audible range 92 may be limited to the first three media objects that appear successively in the media library 28. In an alternative embodiment, the audible range 92 may be configured to include more than three media objects. In yet another alternative, the audible range 92 may be configured to include less than three media objects.

Although in the exemplary embodiment of FIG. 5 the audio sources 82 are spatially arranged so as to be equally spaced along axes 84 and 86 on either side of the user, it will be appreciated that the audio sources 82 may be spatially located in virtual space essentially anywhere in relation to the user. Furthermore, while the audio sources 82 are positioned along either side of the user so as to be in a staggered formation, it will be appreciated that the audio sources 82 may be positioned in any formation, including directly across from each other. The disclosed techniques are not limited to any particular spatial arrangement in its broadest sense. Therefore, the virtual space need not reasonable a hallway, and could represent a circle, a sphere, a star, an elevator, a maze, or any other two- or three-dimensional space.

With additional reference to FIG. 6, illustrated is a schematic representation of a virtual spatial arrangement 94 of audio sources 82 as presented to a user that has shifted position in virtual space. The virtual spatial arrangement 94 of audio sources 82 is the same as the virtual spatial arrangement 80 of audio sources 82 in FIG. 5. However, the user has shifted from the listening position LP_{T1} to the listening position LP_{T2}. For example, the user may have moved forward while browsing the media library 28. Upon moving forward in the library 28, the user is presented with the auditory impression of traveling forward through a virtual space in which audio samples are playing on either side of the user. As the user moves from listening position LP_{T1} to the listening position LP_{T2}, the virtual distances dl and dr of the audio sources 82 correspondingly adjust, which changes the associated spatial gain coefficients. In this manner, the audio data of the audio sources 82 is reproduced in a manner that gives the user the auditory impression of moving towards the audio sources 82 that are in front of the listening position LP_{T1}, and away from the audio sources 82 that are behind or next to the listening position LP_{T1}.

For example, while at the position LP_{T1}, audio sources 82a, 82b, and 82c were audible to the user. Upon moving to listening position LP_{T2}, audio sources 82a and 82b have fallen out of the audible range 92′, but audio source 82c continues to be audible. However, audio source 82c now appears to be located slightly behind the user. This is because the audio data of audio source 82c is being reproduced using new spatial gain coefficients that incorporate the adjusted virtual distances dl_{c2} and dr_{c2} between the left and right ears (88, 90) of the user and audio source 82c. Also at listening position LP_{T2}, audio source 82d has now become audible. The virtual distances between the left and right ears (88, 90) and the audio source 82d may be represented by dl_{d} and dr_{d}, respectively. As the user continues to navigate through the media library 28, different audio sources 82 move in and out of the audible range 92′ in a similar manner.

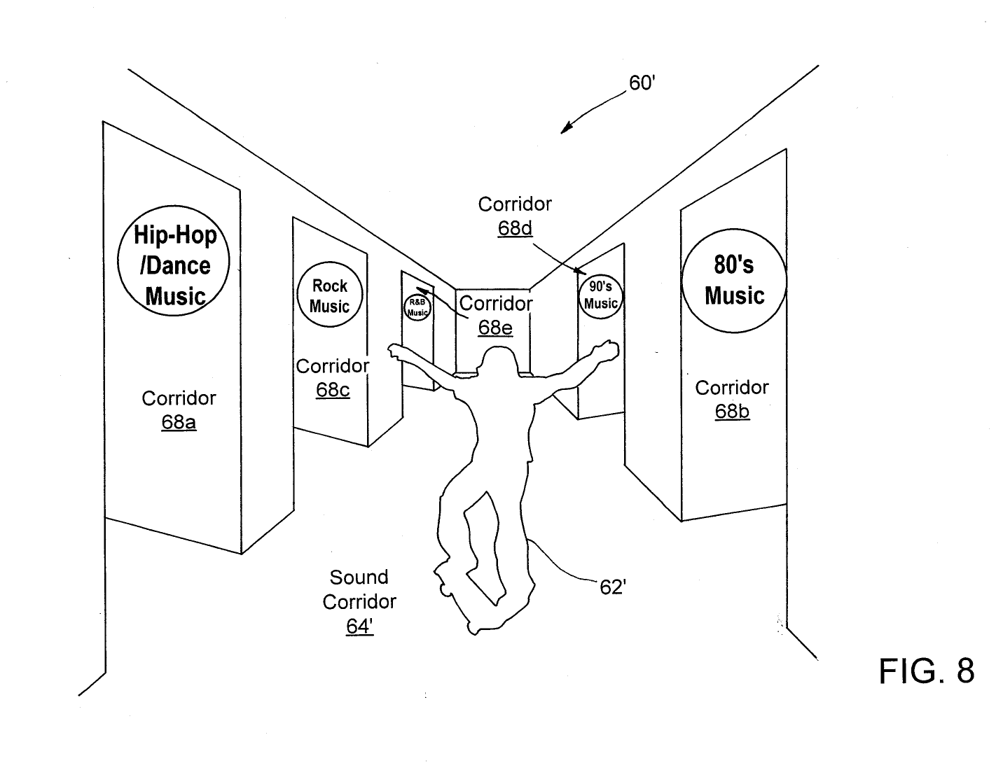

Referring now to FIG. 7, a flowchart is shown that illustrates logical operations to implement an exemplary method of browsing a collection of media files. The exemplary method may be carried out by executing an embodiment of the 3D positional audio function 12, for example. Thus, the flow chart of FIG. 7 may be thought of as depicting steps of a method carried out by the electronic device 10. Although FIG. 7 shows a specific order of executing functional logic blocks, the order of executing the blocks may be changed relative to the order shown. Also, two or more blocks shown in succession may be executed concurrently or with partial concurrence. Certain blocks also may be omitted.

The logical flow for the 3D positional audio function 12 may begin in step 100 where the electronic device 10 has been placed in the 3D positional audio mode for browsing the media library 28 as described herein. The electronic device 10 may have been placed in the 3D positional audio mode via menu navigation keys 20 and display 14, for example, or any other predesignated manner as will be appreciated. Next, in step 102 the control circuit 22 initiates play back of audio samples using 3D positional audio. This gives a user browsing the media library 28 the auditory impression of traveling through a virtual sound corridor 64 in which audio samples of media objects are playing from virtual rooms 66 on either side of the corridor 64 as described in relation to FIG. 3. Only those audio samples that correspond to virtual rooms 66 within the user's audible range 92 are audible as described herein.

In step 104, the control circuit 22 determines whether the user has selected an audio sample from among those currently playing. The user may select an audio sample in any known manner, including via the navigation key(s) 20a and display 14 in the manners described above in relation to FIGS. 3 and 4. If the user has not selected an audio sample as determined in step 104, the electronic device 10 will loop back to step 102 where the control circuit 22 continues to play back audio samples using 3D positional audio as the user browses the media library 28, as shown in FIG. 7. If, on the other hand, the user has selected an audio sample as determined in step 104, the electronic device 10 proceeds to step 106. In step 106, the control circuit 22 causes the 3D positional audio function 12 to play back only the selected audio sample in, for example, stereophonic sound, as described herein. This will give the user the auditory impression of stepping out of the virtual sound corridor 64 and into one of the virtual rooms 66, as described in relation to FIG. 3.

Next, in step 108, the control circuit 22 determines whether the user has selected playback of the media object associated with the selected audio sample. The user may select playback of a media object in any known manner, including via the select key 20b and display 14 in the manners described above in relation to FIGS. 3 and 4. If the user has not selected playback of the media object as determined in step 108, the electronic device 10 proceeds to step 110.

In step 110, the control circuit 22 determines whether the user has de-selected the currently playing audio sample. For example, upon hearing the audio sample in stereophonic sound, the user may decide not to select playback of the media object associated with the currently playing audio sample as described herein. The user may de-select an audio sample in any known manner, including via the navigation key(s) 20a in the manners described above in relation to FIGS. 3 and 4. If the user has de-selected the currently playing audio sample as determined in step 110, the electronic device 10 will loop back to step 102 where the control circuit 22 continues to play back audio samples using 3D positional audio, as shown. This will give the user the auditory impression of stepping out of one of the virtual rooms 66 and back into the virtual sound corridor 64, as described in relation to FIG. 3. If, on the other hand, the user has not de-selected the currently playing audio sample as determined in step 110, the electronic device 10 will simply loop around step 108 as shown.

Referring back to step 108, if the control circuit 22 determines that the user has selected playback of the media object, the electronic device 10 proceeds to step 112. In step 112, the control circuit 22 causes the media player function 26 to begin playback of the currently selected media object from the beginning. Playback of the selected media object will continue until the end, unless the user interrupts playback, e.g., via keypad 18. For example, if the user receives an incoming call during playback of the media object, the user may choose to stop playback and answer the incoming call. Alternatively, the user may decide to stop playback of a media object and go back to browsing the media library 28, in which case the above process may be repeated.

While the above embodiments have been described primarily in the context of browsing media objects in a media library, where the media objects are in the form of media files (e.g., audio files, video files, etc.), the disclosed techniques are not intended to be limited to only those examples described herein. For example, the media library 28 may be made up of objects where the objects themselves represent individual playlists as described above.

Referring now to FIG. 8, illustrated is an exemplary screen display showing a graphical user interface 60′ for browsing a collection of playlists. The graphical user interface 60′ is similar to the graphical user interface 60 shown in FIG. 3. An avatar 62′ is shown in a main sound corridor 64′ that is lined on either side with doorways to corridors 68. Each of the corridors 68 represents a virtual spatial location from which an audio sample of a playlist appears to originate through the use of 3D positional audio. As the user navigates the avatar 62′ through the main sound corridor 64′, the user hears different audio samples playing from each of the virtual corridors 68. In this manner, the user may browse through a collection of playlists.

As shown in FIG. 8, a first corridor 68a represents an audio source playing a sample of a playlist entitled “Hip-Hop/Dance,” while a second corridor 68b represents an audio source playing a sample of a playlist entitled “80's Music.” Similarly, a third corridor 68c represents an audio source playing a sample of a playlist entitled “Rock,” while a fourth corridor 68d represents an audio source playing a sample of a playlist entitled “90's Music.” And a fifth corridor 68e represents an audio source playing a sample of a playlist entitled “R&B.”

According to the exemplary embodiment, a user may select a desired playlist by moving the avatar 62′ into the virtual corridor that is playing the corresponding audio sample. Upon entering one of the corridors 68, the user may be presented with a graphical user interface similar to that shown in FIG. 3, where the sound corridor 64 is lined with rooms 66 that are each playing an audio sample of a media object, such as a song file. A user may select full playback of a media object by entering the corresponding room as described above. For example, if a user wishes to select the 80's Music playlist, the user may navigate the avatar 62′ to the right via, e.g., navigation key(s) 20a, until the avatar 62′ is inside the second corridor 68b. Once inside corridor 68b, the user may browse the 80's Music playlist by navigating the avatar 62′ through the corridor 68b, where each of the rooms (not shown) are playing audio samples of music files included in the 80's Music playlist. The user may return back to sound corridor 64′ by, for example, navigating the avatar back down the corridor 68b towards the doorway leading into sound corridor 64′.

Alternatively, inside each of the corridors 68 may be another set of doorways leading to another set of corridors that represent additional playlists. For example, the third corridor 66c may represent a collection of playlists that fall under the category of Rock Music. As will be appreciated, the user may navigate through such a corridor in accordance with the principles described above. Furthermore, it will be appreciated that the term “playlists” as described herein includes any type of playlist, including, e.g., those that are automatically generated (based on, e.g., artist, album, year of release, genre, mood, etc., and any combination thereof), user-created, uploaded from an external memory, and/or downloaded via an Internet connection.

The audio samples presented to the user while navigating through the sound corridor 64′ may represent randomly selected media objects from each of the playlists. As an alternative, the audio samples may represent the most-played media objects in each of the playlists. As another alternative, the audio samples may represent media objects that fit the user-entered mood of the user. As yet another alternative, the audio samples may represent media objects that have not been played recently, such as, for example, in the last three months. The parameters for defining how the audio samples are selected may be user configurable. Alternatively, default settings may predefine the parameters for selecting the audio samples.

It will be appreciated that FIG. 8 shows only an exemplary graphical user interface in accordance with an embodiment. Changes to the graphical user interface 60′ may be made. For example, a user may browse through a collection of playlists utilizing the 3D positional audio function 12 and a corresponding graphical user interface that is similar to the exemplary graphical user interface of FIG. 4. Alternatively, the user may browse through a collection of playlists utilizing the 3D positional audio function 12 without an accompanying visualization.

In view of the above description, the electronic device 10 may enhance a user's experience when browsing a collection of media objects. Because the disclosed techniques reproduce audio samples of each media object that the user encounters while browsing the collection, the user is provided with an effective tool for remembering forgotten contents of the media collection. Also, because 3D positional audio is used to provide the user with the audible sensation that audio samples are being played back from spatially separated audio sources in a virtual space, the user is able to differentiate between the plurality of simultaneously presented audio samples. This speeds up the browsing process by allowing the user to effectively sample a plurality of media objects at a time and allows a user to obtain an auditory overview of the entire media collection by navigating through the virtual space, if desired.

Although the 3D positional audio function 12 has been described herein as positioning virtual audio sources predominantly on the left and right sides of the user, it will be appreciated that the virtual spatial location from which the audio playback of a media object appears to originate may be in any direction relative to the user, including above, below, in front of, behind of, etc.

Furthermore, in the case where the electronic device 10 includes a motion sensor 50, the user may utilize the motion sensor 50 to enter directional inputs when navigating through a collection of media objects. For example, the user may tilt the electronic device 10 to the right when the user wants to navigate towards a virtual audio source on the right.

Still further, the 3D positional audio function 12 may be utilized to create a playlist. For example, the display 14 may display a graphical user interface, similar to that shown in one of FIG. 3 or FIG. 4, which includes check boxes that are positioned adjacent to respective rooms 66 or entries 72. The check boxes are for selecting the media objects that are to be added to the playlist being created by the user. Using the interface of FIG. 3 as an example, while navigating through the sound corridor 64, the user may “check” the check box that corresponds to a desired media object by navigating the avatar 62 towards the corresponding room and pressing, for example, the select key 20b when the avatar 62 is standing in front of the doorway to that room. Once all desired check boxes have been checked, the user may create a playlist containing the selected media objects using the appropriate functions of the electronic device 10. According to the exemplary embodiment, the user need not enter any of the rooms 66 while creating the playlist, which allows the user to browse through the media library 28 in a quick and efficient manner while obtaining an overview of the contents within the library 28.

Alternatively, the display 14 may display a conventional list of media objects with check boxes for selecting media objects, where the displayed media objects do not graphically correlate with the virtual spatial locations from which the respective audio samples appear to originate. As yet another alternative, instead of utilizing check boxes for selecting desired media objects, any other known manner of selecting an object on a display may be used to select media objects to be added to a playlist, as will be appreciated.

Although certain embodiments have been shown and described, it is understood that equivalents and modifications falling within the scope of the appended claims will lo occur to others who are skilled in the art upon the reading and understanding of this specification.

What is claimed is:

1. An electronic device that plays back a collection of media objects, comprising:
a controller that assigns a virtual spatial location within a virtual space to a sample of each media object and plays back at least one of the samples to a user through a multichannel audio device, wherein each played sample is within a virtual audible range of a virtual user position in the virtual space and wherein each played sample is played using spatial audio so that the user perceives each played sample as emanating from the corresponding virtual spatial location within the virtual space; and
a navigation device that inputs navigational signals to the controller to move the virtual user position relative to the virtual space in accordance with user manipulation of the navigation device,
wherein in response to the received navigational input, the controller adjusts the playback to maintain a correspondence between the virtual spatial location of each played sample and the virtual user position.

2. The electronic device of claim 1, wherein in response to received navigational input to move the virtual user position toward the virtual spatial location of a user specified one of the samples, the controller adjusts the playback so that the user perceives the user specified sample with prominence over other played samples in the virtual audible range to provide user perception of being located at the corresponding virtual spatial location.

3. The electronic device of claim 2, wherein in response to a received input command, the controller plays back the media object corresponding to the user specified sample from a beginning of the media object.

4. The electronic device of claim 1, wherein the adjustment of the playback in response to received navigational input to move the virtual user position toward a user specified sample includes exclusive playback of the user specified sample.

5. The electronic device of claim 1, wherein the adjustment of the playback in response to received navigational input to move the virtual user position toward a user specified sample includes playback of the user specified sample in stereo.

6. The electronic device of claim 1, further comprising:
a display driven to display a graphical simulation of the virtual space, the graphical simulation including graphical objects that represent the virtual spatial locations of the samples, wherein the graphical simulation is updated in response to the received navigational inputs.

7. The electronic device of claim 1, wherein each media object is an individual audio file.

8. The electronic device of claim 1, wherein each media object is a playlist having plural audio files.

9. The electronic device of claim 8, wherein in response to a received input command, the controller plays back samples of the audio files from the playlist using spatial audio to represent a spatial layout of the audio files.

10. The electronic device of claim 1, wherein each media object is associated with at least one audio file or at least one video file.

11. The electronic device of claim 1, wherein the navigation inputs are generated by moving the electronic device.

12. A method of browsing a collection of media objects using an electronic device, comprising:
(a) assigning a virtual spatial location within a virtual space to a sample of each media object;
(b) playing back at least one of the samples to a user through a multichannel audio device, wherein each played sample is within a virtual audible range of a virtual user position in the virtual space and wherein each played sample is played using spatial audio so that the user perceives each played sample as emanating from the corresponding virtual spatial location within the virtual space; and
(c) in response to a received navigational input to move the virtual user position relative to the virtual space, adjusting the playback to maintain a correspondence between the virtual spatial location of each played sample and the virtual user position.

13. The method of claim 12, wherein in response to received navigational input to move the virtual user position toward the virtual spatial location of a user specified one of the samples, adjusting the playback so that the user perceives the user specified sample with prominence over other played samples in the virtual audible range to provide user perception of being located at the corresponding virtual spatial location.

14. The method of claim 13, wherein in response to a received input command, playing back the media object corresponding to the user specified sample from a beginning of the media object.

15. The method of claim 12, wherein the adjusting of the playback in response to received navigational input to move the virtual user position toward a user specified sample includes exclusively playing back the user specified sample.

16. The method of claim 12, wherein the adjusting of the playback in response to received navigational input to move the virtual user position toward a user specified sample includes playing back the user specified sample in stereo.

17. The method of claim 12, further comprising:
displaying a graphical simulation of the virtual space, the graphical simulation including graphical objects that represent the virtual spatial locations of the samples; and
updating the graphical simulation in response to the received navigational inputs.

18. The method of claim 12, wherein each media object is an individual audio file.

19. The method of claim 12, wherein each media object is a playlist having plural audio files.

20. The method of claim 19, wherein in response to a received input command, repeating steps (a), (b), and (c) using the audio files of a user specified one of the playlists as the media objects.
